(19) United States
(12) Patent Application Publication
(10) Pub. No.: US 2021/0125163 A1
(43) Pub. Date: Apr. 29, 2021

(54) System and method of enforcing and monitoring contracts

(71) Applicant: Three Lefts Inc., Toronto (CA)

(72) Inventors: Romeo OPOKU-WARE, Brampton (CA); Matthew R. RAPPARD, Toronto (CA)

(21) Appl. No.: 17/141,973

(22) Filed: Jan. 5, 2021

Related U.S. Application Data
(63) Continuation of application No. PCT/CA2019/050925, filed on Jul. 4, 2019.
(60) Provisional application No. 62/694,330, filed on Jul. 5, 2018.

(51) Int. Cl. G06Q 20/12; G06Q 50/18; G06Q 20/06; H04L 9/06; H04L 9/32

(52) U.S. Cl. CPC G06Q 20/1235; G06Q 50/184; G06Q 20/0658; H04L 2209/38; H04L 9/3247; G06Q 2220/127; G06Q 2220/18; H04L 9/0643

(57) ABSTRACT

There is provided a method of enforcing a contract for the access of content, using a blockchain comprising a unique identifier of the content, a one or more digital contracts for the use of the content, and a public key. Tokens are generated with a private key associated with the public key and used to provide access to the content. A chain of ownership can be identified from the digital contracts on the blockchain.

### CROSS-REFERENCE TO RELATED APPLICATION(S)

This application is a continuation of PCT Application No. PCT/CA2019/050925 filed on Jul. 4, 2019, which claims priority to U.S. Provisional Patent Application No. 62/694,330 filed on Jul. 5, 2018, both incorporated herein by reference in their entireties.

### TECHNICAL FIELD

The following relates to computer-implemented systems and methods for monitoring and validating transactions.

### BACKGROUND

Intellectual property (“IP”), such as copyrights, trademarks, and patents, may be transferred or licensed by a creator of the intellectual property to one or more licensees. For example, media properties such as video files or music may be licensed by the creator for use in a multimedia production produced by a licensee. The transfers and/or licenses have terms and conditions set out in a paper contract, and every agreement between the creator and one licensee may be written out in a separate contract. The licensees may integrate the intellectual property into a product or project or sell the intellectual property directly to other companies or consumers, requiring additional terms and conditions to be set out in contracts between the licensees and the other companies or consumers.

Various challenges can arise when using paper contracts to enforce the terms and conditions for the use of intellectual property. For example, it is common for the terms and conditions describing the allowable use of one piece of intellectual property to be set out in a plurality of different contracts, as would be the case when the creator of the intellectual property licenses it to a plurality of distributors, where each distributor sublicenses the intellectual property to one or more other sub-distributors. Validation of the transfer and ownership may be time consuming, expensive, and/or prone to failure if the intellectual property is licensed and sublicensed to many parties, as the plurality of different contracts are not linked and/or in communication. As such, the creator of the intellectual property may be unable to effectively monitor and enforce the sublicenses between the distributors and sub-distributors or the agreements between sub-distributors and end users. Additionally, it may be difficult for parties to respond to changes to contracts or licenses between other parties. For example, if a license between the creator and a distributor is cancelled prematurely, a sub-distributor sublicensing the intellectual property from the distributor may continue to use the intellectual property if they are unaware that the license has been prematurely cancelled.

A licensee licensing the intellectual property from the creator may further license the intellectual property to other parties. As such, it can be difficult to track and prove the full ownership of the intellectual property and the chain of licenses between the creator and an end user, as the chain of ownership may be fragmented between multiple contracts between the creator, licensee, sub-licensees, and the end user. It may similarly be difficult for a party to access information regarding the terms and conditions agreed to by other parties.

Different parties may be required to abide by different terms and/or conditions, complicating the creator's ability to monitor the use of the intellectual property and assert ownership rights to enforce the correct terms and conditions. As such, the chain of ownership may be rendered unenforceable, and the ability of the creator to monetize the intellectual property may be limited.

In existing blockchain platforms, one may have difficulty or be unable to validate that a traditional contract exists, create a chain of ownership between contract to contract, validate the chain of contracts as valid, send money that is filtered by a series of contracts among multiple participants in a single transaction, or have an off-chain transaction token.

It is an object of the following to address at least one of the above-noted disadvantages.

### SUMMARY

In a first aspect, there is provided a system for enforcing a contract for the use of intellectual property comprising: content stored on or accessible to a content server; an interface for an end user; and a blockchain on a distributed ledger; wherein: the blockchain comprises a unique identifier of the content, one or more digital contracts for the use of the content, and a public key; one or more tokens generated with a private key associated with the public key, the one or more tokens being provided by the end user to the content server; the content server is configured to validate the one or more tokens provided by the end user and provide access to the content; the content server is configured to identify a chain of ownership from the blockchain; and the blockchain is configured to transfer payment from the end user to parties in the chain of ownership.

In another aspect, there is provided a method of enforcing a contract for the use of intellectual property, the method comprising: receiving content at a content server and assigning a unique identifier to the content; uploading the unique identifier to a blockchain comprising a distributed ledger; uploading the contract between a licensor and a licensee to the blockchain; generating a public key and a private key; uploading the public key to the blockchain; providing the licensee with the private key; receiving a transaction token that has been generated using the private key; and enabling access to the content using the transaction token.

In yet another aspect, there is provided a computer readable medium storing instructions for performing the method.

In yet another aspect, the token is added to the blockchain after being used to access the content.

In yet another aspect, the one or more digital contracts encode the terms and conditions of one or more first written contracts between a creator of the content and one or more licensees.

In yet another aspect, the one or more digital contracts also encode the terms and conditions of a written contract between the one or more licensees and one or more sub-licensees.

In yet another aspect, the one or more licensees generate the one or more tokens

In yet another aspect, the one or more digital contracts specify different prices for different distribution rights and different geographic regions.

### BRIEF DESCRIPTION OF THE DRAWINGS

Embodiments will now be described with reference to the appended drawings wherein:

FIG. 1 is a schematic diagram of a computing environment for an IP access control system;

FIG. 2 is a flow diagram illustrating the IP access control system of FIG. 1;

FIG. 3 is a flow diagram illustrating the process of a user accessing the IP;

FIG. 4 is a flow diagram illustrating a validation step of a transaction token provided by the user;

FIG. 5 is a schematic diagram of a blockchain used as a registry for IP rights in the system of FIG. 1;

FIG. 6 is a schematic diagram of a licensing token used in the validation of FIG. 4;

FIG. 7 is a schematic diagram illustrating an example of a chain of ownership;

FIG. 8 is a diagram illustrating the distribution of payments for different rights in different geographic regions; and

FIG. 9 is a diagram illustrating an example of a tiered payment distribution.

### DETAILED DESCRIPTION

To monitor and monetize the use of intellectual property; a system comprising a blockchain network, distributed ledger, or other decentralized network can be utilized, in which the blockchain network is configured to implement an electronic contract or other computer protocol that allows the self-execution, verification, and enforcement of a written legal contract through the encoding of a set of contractual clauses set out in the written contract into the blockchain.

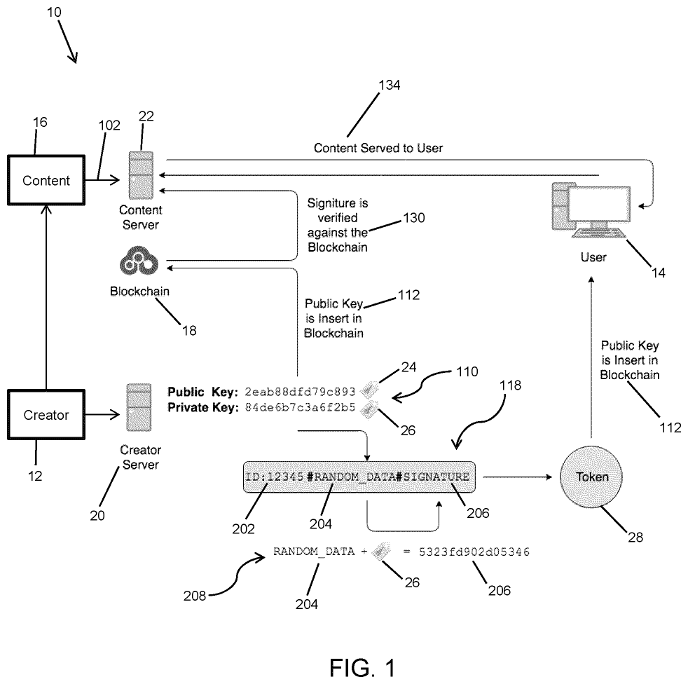

Turning now to the figures, FIG. 1 provides an example of a computing environment for implementing an intellectual property (“IP”) access control system 10 in which a blockchain 18 is configured to monitor and verify the access of an element or piece of content 16 by one or more users 14. The blockchain 18 is a secured, immutable ledger on a distributed network comprising a plurality of nodes, for example Ethereum and R3, that is, ledger or computation blockchains 18. However, it should be appreciated that any other immutable ledger and/or distributed network configurations may also be utilized.

The user 14 may require access to the content 16 owned by a creator 12. The creator 12 is understood to be the individual or party that generated the content 16 and/or the individual or party that owns the content 16. The content 16 may be protected by a patent, trademark, copyright, or any other type of intellectual property that is capable of being licensed. For example, the content 16 may be a copyrighted image.

A third party may wish to license the content 16 from the creator 12, for example a consumer may wish to listen to music produced by an artist. Another party may wish to license the content 16 from the creator 12 to sell to other parties, for example a music distribution service may license music from a collection of artists and charge consumers a monthly fee for access to the music.

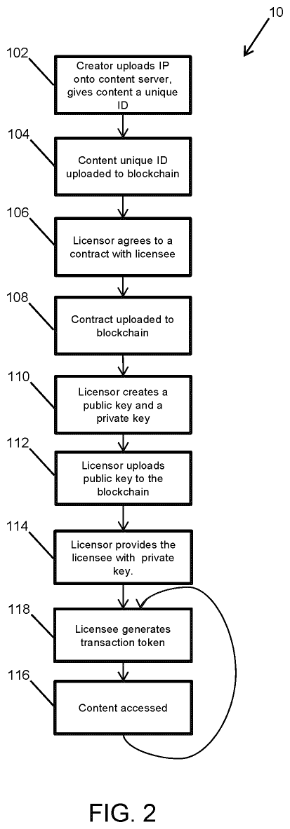

FIG. 2 provides a flow diagram illustrating a workflow executed by the system 10. At step 102, the creator 12 of the content 16 uploads the content 16 onto a content server 22. The content 16 is assigned a unique identification (UID) 202. The UID is added to the blockchain 18 at 104, such that one blockchain 18 is associated with each element or piece of content 16 through the unique identification 202.

At 106, the creator 12 agrees to a contract with a licensee 13 for the use of the content 16. The contract includes terms and conditions describing how the creator 12 allows the licensee 13 to use the content 16. For example, the contract may allow the licensee 13 to use the content 16 in a specific geographic location, in a specific language, and at a certain time. The contract may also allow the licensee 13 to further sub-license the content 16, for example the licensee 13 may be allowed to sub-license the content to one or more sub-licensors 15 who sell the content. Such licensing and sub-licensing creates a chain of ownership from the creator 12 to the end user 14. The contract may also include an agreement of the compensation provided by the licensee 13 to the creator 12 for the use of the content 16.

At step 108, the terms and conditions of the contract are encoded into a digital contract 32, which is uploaded to the blockchain 18. The creator 16 generates one or more encryption keys at 110. In this example, a public key 24 and a private key 26 are generated. The public key 24 is added to the blockchain 18 at 112. At 114, the creator 16 provides the licensee 13 with the private key 26.

The licensee 13 can use the private key 26 to generate a transaction token 28 at 118, as described in greater detail below. The transaction token 28 can be used once by the licensee 13 to access the content 16 at 116. The licensee may access the content 16 multiple times by generating additional transaction tokens 28. The transaction token 28 may also be used by other parties to access the content 16. For example, the licensee 13 may sell the transaction token to an end user 14, who uses the transaction token 28 to access the content 16. The licensee 13 may also allow the other parties to generate the transaction tokens 28. For example, if the licensee 13 has a sub-licensing agreement with the sub-licensor 15, the sub-licensor 15 may be allowed to generate the license token 28.

As can be seen in FIG. 1, the transaction token 28 comprises a signature 206 generated by the private key 26, such that the token 18 may be verified by any device having access to the public key 24 on the blockchain 18. In this example, the transaction token 28 comprises the UID 202 of the content 16, a set of random data 204, and the digital signature 206. The signature 206 is generated at 208 by signing the random data 204 with the private key 26. However, it should be appreciated that the transaction token 28 may comprise any other information such that it is associated to the blockchain 18 corresponding to the specific content 16 and may be validated by the public key 24.

The generation of the token 28 at 118 may be done offline by the licensee 13 such that the token 28 remains private. The licensee 13 may also assign the right to generate tokens to other parties, such as the sub-licensor 15. The token 28 may be generated at any time, and stored indefinitely until used to access the content 16. Upon receiving the private key 26, the licensee 13 can generate multiple transaction tokens 28 and provide one transaction token 28 to the end user 14 each time that the end user 14 accesses the content 16.

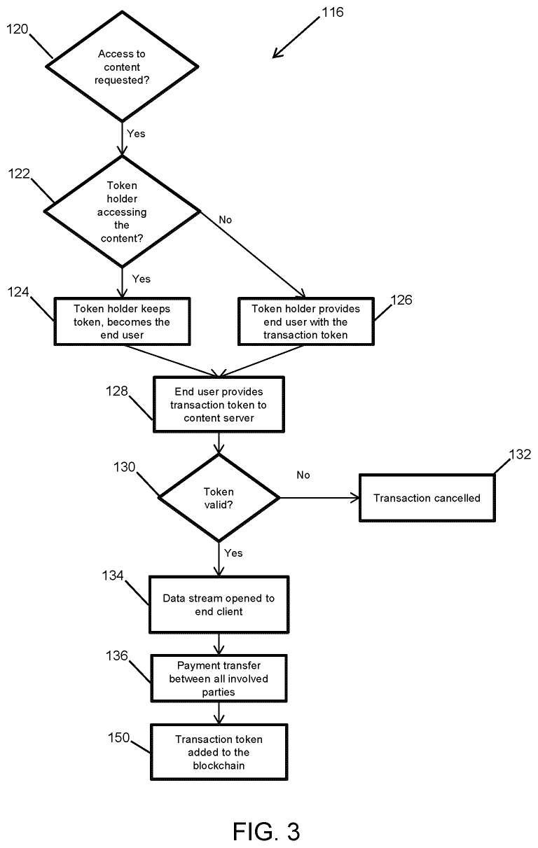

FIG. 3 provides a flow diagram illustrating the process of the end user 14 accessing the content 16 by performing a transaction with the content server 22 at step 116. The token holder stores one or more tokens 28 at 120, until the access to the content 16 is requested. The token holder may be the party that generated the token 28, for example the licensee 13 or the sub-licensor 15. The token holder may also be a party provided with tokens 28 from the party that generated the token 28, for example a sub-licensor 15 who is provided tokens generated by the licensee 13. At 122, the token holder identifies the party that is requesting access to the content 16. If the token holder is accessing the content 16, then the token holder keeps the transaction token 28 and becomes the end user 14 at 124. However, if another party is accessing the content 16, for example if the content 16 is a soundtrack included in a multimedia production produced by the token holder for sale to an end user 14, the token holder provides the end user 14 with the transaction token 28 at 126.

At 128 the end user 14 provides the transaction token 28 to the content server 22. The content server 22 validates the token 28 at 130, as described in greater detail below. If the token 28 provided by the end user 14 is invalid, the transaction is cancelled at 132. If the token 28 is determined to be valid, the content server 22 opens a data stream to the end user 14, allowing the end user 14 to access the content 16. The access granted to the end user 14 may be limited by the digital contract 32, for example the end user 14 may only be allowed to access the content 16 once for a certain length of time. When the end user 14 has received access to the content 16, payment is transferred between all involved parties at step 136, as described in greater detail below. The used transaction token 28 is added to the blockchain 18 at step 150, such that the same token 28 cannot be used more than once to access the content 16.

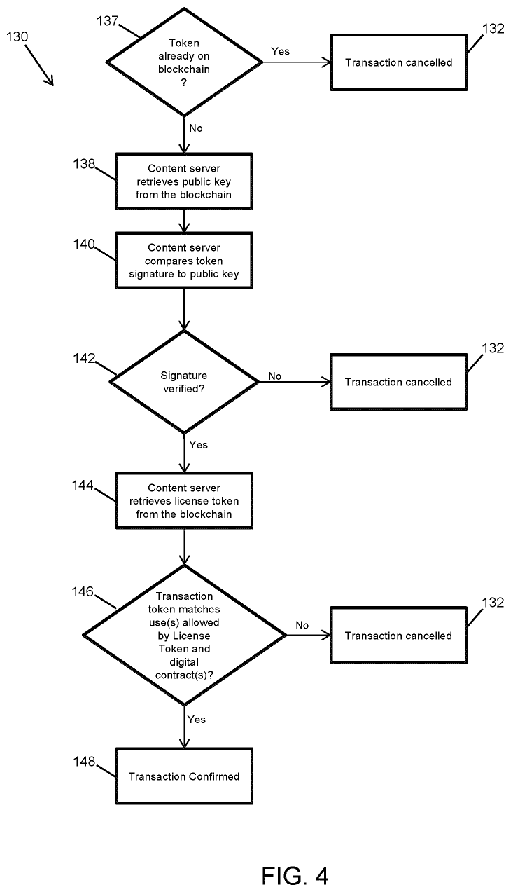

FIG. 4 provides a flow diagram illustrating the process of validating the transaction token 28 at step 130. Upon receiving the transaction token 28 from the end user 14 at 128, the content server 22 checks the blockchain 18 for identical transaction tokens at 137. If an identical transaction token 28 is on the blockchain 18, the transaction is cancelled at 132 as the transaction token 28 was previously used to access the content 16. If the transaction token 28 is not found on the blockchain 18, the transaction token 28 represents a unique access to the content 16 and the content server 22 retrieves the public key 24 from the blockchain 28 at 138. The content server 22 is configured to verify the signature 206 of the token 28 with the public key at 140. If at 142, the signature 206 is not verified by the public key 24, the transaction is cancelled at 132. If the signature is verified by the public key 24, the content server 22 verifies that the requested use meets the terms and conditions set out in the digital contract 32 at 146. The content server 22 records information related to the requested access of the content 16, for example the time or the geographic location of the user 14, and compares the information to the digital contract 32 recorded on the blockchain 18. The content server 22 may also verify the chain of ownership against the digital contract 32 on the blockchain 18, as described in greater detail below. If the requested access of the content 16 is allowed by the digital contract 32, the transaction is confirmed at 148.

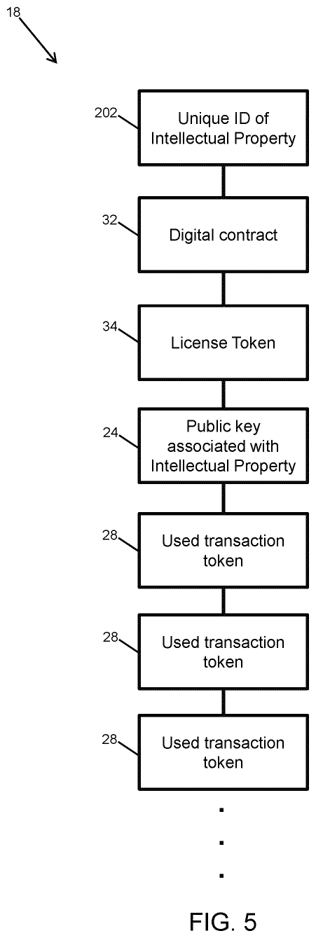

FIG. 5 is a schematic diagram of the blockchain 18 used to verify the access to the content 16. One blockchain 18 is associated with one piece of content 16, and comprises blocks containing information related to the one piece of content 16, for example its allowed uses and records of all previous uses.

In this example, the blockchain 18 comprises the unique ID 202, the digital contract 32, a license token 34, the public key 24, and one or more used transaction tokens 28. The Unique ID 202 of the content 16 associates the blockchain 18 with the correct piece of content 16. The digital contract 32 and the license token 34 represent an agreement between two or more parties on the allowed uses of the content 16. For example, the digital contract 32 and the license token 34 can be between the creator 12 and the licensee 13, specifying the time and locations that the content 16 may be accessed. It should be understood that more than one digital contract 32 and/or license token 34 may exist on the blockchain 18 if multiple agreements for the use of the content 16 exist, for example if there is a first agreement between the creator 12 and the licensee 13 and a second agreement between the licensee 13 and the sub-licensor 15. The public key 24 allows the content server 22 to use the blockchain 18 to validate the transaction token 28, as described above. The used transaction tokens 28 allow the content server 22 to prevent the end user from using one transaction token 28 to access the content 16 multiple times.

The blockchain 18 may be stored as a decentralized ledger over several nodes which may be located around the world. The system 10 can be implemented such that the end user 14 provides the content server 22 with the transaction token 28 such that the content server 22 accesses the blockchain 18 to determine if the end user 14 is allowed to access the content 16. In such a system, the end user 14 does not access the blockchain 18.

The content server 22 can use the blockchain 18 to validate the chain of ownership when the end user 14 requests access to the content 16. In this example, the end user 14 requests access to the content 16 by providing the content server 22 with a transaction token 28. The content server 22 retrieves the public key 24 from the blockchain 18 at step 138 (FIG. 4) and validates the signature 206 of the transaction token 28 using the public key 24 at step 140. Upon validation of the signature 206 using the public key 24, the content server 22 can identify the licensor 13 that generated the transaction token 28 by checking the blockchain 18 to determine which licensor 13 was provided with the corresponding private key 26. The content server 22 can then compare the requested use of the content 16 to the allowed uses of the content 16 set out in the digital contract 32 and/or license token 34.

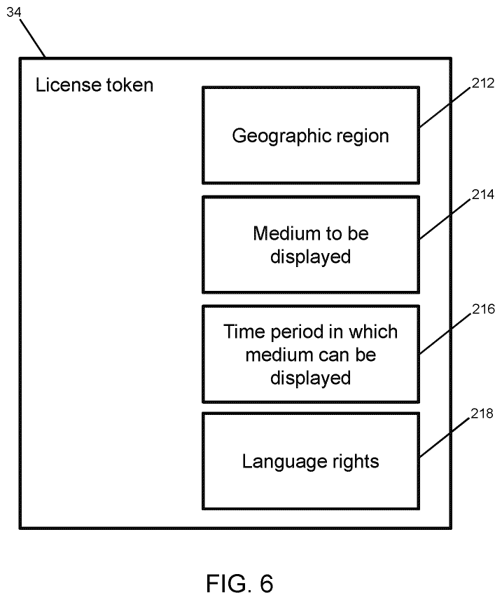

FIG. 6 is a schematic diagram of the license token 34 used to verify that the use of the content 16 meets the terms and conditions set out in the digital contract 32. In this example, the license token 34 comprises a geographical region component 212, a display medium component 214, a time component 216, and a language component 218. The geographical region component 212 specifies the geographic regions in which the content 16 may be accessed. The display medium component 214 specifies the medium that may be used to display the content 16, for example a video on a mobile device or audio on any device. The time component 216 specifies the time or range of times during which the content 16 can be accessed. The language component 218 specifies the language that the content 16 can be displayed in, for example English or French.

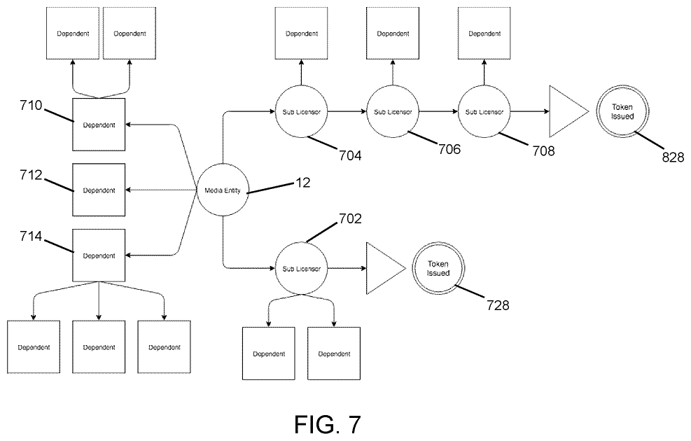

FIG. 7 is an example of a chain of ownership of the content 16. In this example, the creator 12 licenses the content 16 to two licensors 13, in this example a first licensor 702 and a second licensor 704. The first licensor 702 generates a first transaction token 728, which may be provided to the content server 22 to access the content 16. The second licensor 704 further licenses the content 16 to a first sub-licensor 706, which subsequently licenses the content to a second sub-licensor 708. The second sub-licensor 708 generates a second transaction token 828, which may be provided to the content server 22 to access the content 16.

As described above, the content server 22 is able to identify the chain of ownership when provided with a transaction token 28. In this example, when the first transaction token 728 is provided to the content server 22, the content server 22 identifies that the first transaction token 728 was generated by the first licensor 702. The content server 22 is also able to collect information from the digital contracts 32 on the blockchain 18 to identify that the creator 12 licensed the content 16 to the first licensor 702. When the second transaction token 728 is provided to the content server 22, the content server 22 identifies that the second transaction token 828 was generated by the second sub-licensor 708. The content server 22 is also able to collect information from the digital contracts 32 on the blockchain 18 to identify that the creator 12 licensed the content 16 to the second licensor 704, who sub-licensed the content 16 to the first sub-licensor 706, who further sub-licensed the content 16 to the second sub-licensor 708. Such identification of the chain of ownership allows the distribution of payment between the involved parties, as described below.

Each party in the chain of ownership may be required to pay one or more dependents upon receiving funds from access to the content 16. In this example, the creator is required to pay a first dependent 710, a second dependent 712, and a third dependent 714.

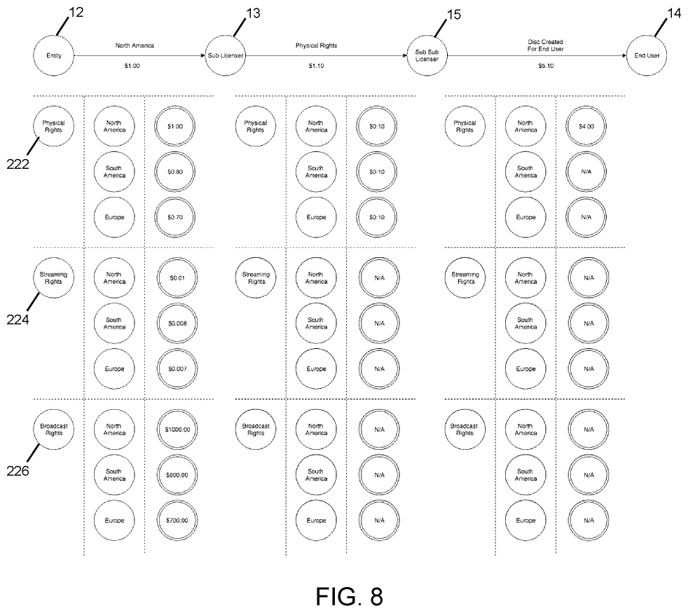

FIG. 8 illustrates one example of the distribution of payments for different rights in different regions. The creator 12 may set different prices for different uses of the content 16. For example, the creator 12 may have different prices for different distribution rights, such as physical rights 222 or the rights to sell a physical unit containing the content 16, streaming rights 224 or the rights to view the content 16 online, and broadcasting rights 226. The creator 12 may also set different prices for different geographic regions. In this example, the creator 12 set a price of $1.00 for physical rights in North America.

The licensor 13 may similarly set different prices for different uses of the content 16. In this example, the licensor 13 set a price of $0.10 for physical rights 222 in all regions, and does not sell streaming rights 224 and broadcasting rights 226. Such a licensing agreement may allow the licensor 13 to specialize in distributing physical rights, and the creator 12 to distribute usage rights to a plurality of licensors 13 each specializing in different forms of distribution.

In this example, the licensor 13 sells physical rights 222 to the sub-licensor 15. The sub-licensor 15 distributes the physical rights 222 to the content 16 to end users 14 in North America. The sub-licensor 15 charges $4.00 for the physical rights 222 in this example. The end user 14 pays the sum of the prices set by the creator 12, licensor 13, and sub-licensor 15 for the North American physical rights, in this example $5.10. The payment from the end user 14 is automatically deducted from the user 14 and distributed between the parties in the chain of ownership by the blockchain 18.

The prices set by each party are set in the digital contracts 32. For example, the digital contract 32 between the creator 12 and the licensee 13 can specify that any streaming access 224 to the content 16 by the licensee 13 and/or any party sub-licensing the content 16 from the licensee 13 will result in the creator 12 being paid $0.01. As such, the prices may dynamically change, as described below. When the transaction token 28 is used to access the content 16, the content server 22 identifies the chain of ownership as described above and identifies the price set by each party in the chain of ownership.

In the example illustrated in FIG. 8, the chain of ownership starts from the creator 12, who licenses the content 16 to the licensee 13, who further sub-licenses the content 16 to the sub-licensor 15. The sub-licensor 15 sells the physical rights 222 in North America to the end user 14. When the end user 14 accesses the content 16 by using the transaction token 28, the content server retrieves the price charged by each party for physical rights 222 in North America from the digital contracts 32 on the blockchain 18. In this example the creator charges $1.00 for physical rights 222 in North America, the licensee 13 charges $0.10 for physical rights 222 in North America, and the sub-licensor 15 charges $4.00 for physical rights 222 in North America. As such, a total of $5.10 is deducted from the end user 14 and distributed among the creator 12, licensee 13, and sub-licensor 15 by the blockchain 18.

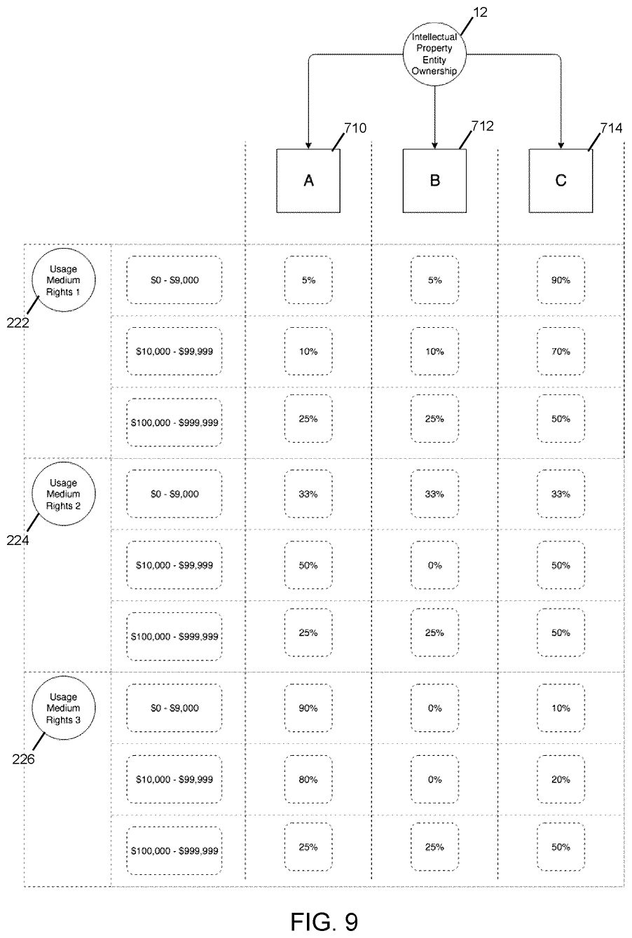

FIG. 9 illustrates an example of a tiered payment distribution. The payment of dependents by the parties on the chain of ownership may depend on the total revenue earned by the party on the chain of ownership. In this example, the creator is required to divide the payment between the first dependent 710, the second dependent 712, and the third dependent 714 differently when earning different revenue for different rights. The revenue from physical rights 222 is divided into three tiers: $0 to $9,000 of revenue, $10,000 to $99,999 of revenue, and $100,000 to $999,999 of revenue. In each tier, the revenue is divided between the dependents 710, 712, 714 differently. For example, when the creator 12 receives $0 to $9,000 in revenue, 5% of the earned revenue is paid to the first dependent 710, 5% of the earned revenue is paid to the second dependent 712, and 90% of the earned revenue is paid to the third dependent 714. Similar tiered payment distributions may also exist for streaming rights 224 and broadcast rights 226. The tiered payment distribution may be specified in the digital contract 32, and implemented by the content server 22 and/or the blockchain 18.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10 (e.g., content server 22), any component of or related to thereto, etc., or accessible or connectable thereto. Any application or module herein described may be implemented using computer readable/executable instructions that may be stored or otherwise held by such computer readable media.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A system for enforcing a contract for the use of intellectual property comprising:
content stored on or accessible to a content server;
an interface for an end user; and
a blockchain on a distributed ledger; wherein:
the blockchain comprises a unique identifier of the content, one or more digital contracts for the use of the content, and a public key;
one or more tokens generated with a private key associated with the public key, the one or more tokens being provided by the end user to the content server;
the content server is configured to validate the one or more tokens provided by the end user and provide access to the content;
the content server is configured to identify a chain of ownership from the blockchain; and
the blockchain is configured to transfer payment from the end user to parties in the chain of ownership.

2. The system of claim 1, wherein the token is added to the blockchain after being used to access to the content.

3. The system of claim 2, wherein the one or more digital contracts encode terms and conditions of one or more first written contracts between a creator of the content and one or more licensees.

4. The system of claim 3, wherein the one or more digital contracts further encode terms and conditions of one or more second written contracts between the one or more licensees and one or sub-licensors.

5. The system of claim 4, wherein the one or more licensees generate the one or more tokens.

6. The system of claim 4, wherein the one or more sub-licensors generate the one or more tokens.

7. The system of claim 5, wherein the one or more licensees provide the end user with the one or more tokens.

8. The system of claim 4, wherein the one or more digital contracts specify different prices for different distribution rights and different geographic regions.

9. A method of enforcing a contract for the use of intellectual property, the method comprising:
receiving content at a content server and assigning a unique identifier to the content;
uploading the unique identifier to a blockchain comprising a distributed ledger;
uploading the contract between a licensor and a licensee to the blockchain;
generating a public key and a private key;
uploading the public key to the blockchain;
providing the licensee with the private key;
receiving a transaction token that has been generated using the private key; and
enabling access to the content using the transaction token.

10. The method of claim 9, further comprising:
validating the transaction token to enable the access;
identifying a chain of ownership from the blockchain; and
transferring payment from an end user associated with the licensee to parties in the chain of ownership.

11. The method of claim 10, wherein enabling the access to the content further comprises:
determining if a token holder is requesting access to the content, if so the token holder corresponds to the end user, if not, the token holder provides the end user with the transaction token; and
receiving the transaction token at the content server from the end user.

12. The method of claim 10 further comprising:
determining if the received transaction token is valid and, if not, cancelling the transaction; and
when the transaction token is valid, opening a data stream for the content to the end user prior to initiating a payment transfer between parties.

13. The method of claim 11 further comprising:
determining if the received transaction token is valid and, if not, cancelling the transaction; and
when the transaction token is valid, opening a data stream for the content to the end user prior to initiating a payment transfer between parties.

14. The method of claim 12 further comprising adding the transaction token to the blockchain.

15. The method of claim 13 further comprising adding the transaction token to the blockchain.

16. The method of claim 12 wherein validating the transaction token comprises:
determining if the transaction token is already on the blockchain and, if so, cancelling the transaction;
when the transaction token is not already on the blockchain:
retrieving the associated public key from the blockchain;
comparing the token signature to the public key to verify the signature;
when the signature is verified, retrieving a license token from the blockchain and comparing the license token with the contract;
wherein the transaction is confirmed when the digital contract is satisfied.

17. The method of claim 13 wherein validating the transaction token comprises:
determining if the transaction token is already on the blockchain and, if so, cancelling the transaction;
when the transaction token is not already on the blockchain:
retrieving the associated public key from the blockchain;
comparing the token signature to the public key to verify the signature;
when the signature is verified, retrieving a license token from the blockchain and comparing the license token with the contract;
wherein the transaction is confirmed when the digital contract is satisfied.

17. The method of claim 16, wherein the license token comprises one or more or: an indication of a geographic region, an indication of a medium to be displayed, an indication of a time period in which the medium can be displayed; and an indication of language rights.

18. A computer readable medium comprising computer executable instructions for performing the method of claim 17.
